(19) United States
(12) Patent Application Publication
(10) Pub. No.: US 2020/0068865 A1
(43) Pub. Date: Mar. 5, 2020

(54) RETRIEVABLE CHUM DISPENSER

(71) Applicant: SBM LLC OF NASHUA, Windham, NH (US)

(72) Inventors: Robert Kahl, Windham, NH (US); Linda A. Morrison, Windham, NH (US)

(21) Appl. No.: 16/550,897

(22) Filed: Aug. 26, 2019

Related U.S. Application Data
(60) Provisional application No. 62/724,329, filed on Aug. 29, 2018.

(51) Int. Cl. A01K 97/02; A01K 93/00; A01K 95/00

(52) U.S. Cl. CPC A01K 97/02; A01K 2227/40; A01K 95/00; A01K 93/00

(57) ABSTRACT

A chum dispenser system comprises a lower housing shell defining a lower cavity and an upper housing shell defining an upper cavity. The upper housing shell is removably attachable to the lower housing shell, the upper and lower cavities defining an interior compartment when the upper housing shell is attached to the lower housing shell. The upper housing shell has one or more perforations extending therethrough to fluidically couple the interior compartment and an exterior environment. In certain embodiments, two or more interchangeable buoyancy members are configured to be removably and interchangeably received within the lower housing shell, wherein each of the two or more buoyancy members have a receptacle formed therein for holding a supply of chum material.

### CROSS-REFERENCE TO RELATED APPLICATION

This application claims the priority benefit of U.S. provisional application Ser. No. 62/724,329 filed Aug. 29, 2018. The aforementioned application is incorporated herein by reference in its entirety.

### BACKGROUND

The present disclosure relates to fishing tackle for fresh and salt water fishing and, more particularly, to a retrievable, refillable chum dispenser for delivering a fish attracting substance to a specific location in the water by casting the dispenser to a desired location, e.g., using a fishing pole.

Commonly, chum devices are configured to hang on the back or side of a boat with the hopes to lure the fish to the vicinity of boat. Other devices, such as disclosed in U.S. Publication No. 2014/0234473, are configured to be dropped or thrown in the water, but are not retrievable.

The present disclosure contemplates a new and improved chum dispensing apparatus and method which overcome the above-referenced problems and others.

### SUMMARY

In one aspect a chum dispenser system comprises a lower housing shell defining a lower cavity and an upper housing shell defining an upper cavity. The upper housing shell is removably attachable to the lower housing shell, the upper and lower cavities defining an interior compartment when the upper housing shell is attached to the lower housing shell. The upper housing shell has one or more perforations extending therethrough to fluidically couple the interior compartment and an exterior environment. Two or more interchangeable buoyancy members are configured to be removably and interchangeably received within the lower housing shell, wherein each of the two or more buoyancy members have a receptacle formed therein for holding a supply of chum material.

In a more limited aspect, each of the two or more buoyancy members has a different specific gravity.

In another more limited aspect, the two or more buoyancy members include a first buoyancy member having a specific gravity configured to produce a buoyant force when the chum dispenser system is placed in water and a second buoyancy member having a specific gravity configured to produce a sinking force when the chum dispenser system is placed in water.

In yet another more limited aspect, the first buoyancy member comprises one or more of a cork material, a foam material, and a substantially hollow watertight enclosure.

In still another more limited aspect, the first buoyancy member comprises a closed cell foam material.

In another more limited aspect, the second buoyancy member comprises a material selected from the group consisting of a metal, metal alloy, cementitious material, composite material, tungsten, lead, steel, stainless steel, brass, bronze, bismuth, tin, and any combination of the foregoing.

In yet another more limited aspect, the chum material is a dispersible fish attractant material selected from the group consisting of fish, krill, worms, squid, amphibians, fish food, fish bait, fish scents, oils, and any combination of the foregoing.

In still another more limited aspect, the chum material comprises a fish attractant encapsulated within a water soluble material.

In another more limited aspect, the water soluble material is selected from the group consisting of a gelatin capsule and a water soluble polymer film.

In still another more limited aspect, the fish attractant comprises freeze dried fish bait.

In yet another more limited aspect, the chum material is a tablet.

In another more limited aspect, the tablet comprises a water soluble coating.

In yet another more limited aspect, The chum dispenser system of claim 1, wherein the lower housing shell includes a first threaded fastening element and the upper housing shell includes a second threaded fastening element which is complementary with the first threaded fastening element, the first and second threaded fastening elements for rotatable attaching the lower housing shell to the upper housing shell.

In still another more limited aspect, the first threaded fastening element includes an external helical thread adjacent an open end of the lower housing shell and wherein the second threaded fastening element includes an internal helical thread adjacent an open end of the upper housing shell.

In yet another more limited aspect, the first threaded fastening element includes an internal helical thread adjacent an open end of the lower housing shell and wherein the second threaded fastening element includes an external helical thread adjacent an open end of the upper housing shell.

In yet another more limited aspect, each of the lower and upper housing shells are hemispherical in shape.

In another more limited aspect, at least one of the upper housing shell and the lower housing shell further comprises a loop for attaching the chum dispenser system to a fishing line.

In a further aspect, a chum dispenser system comprises a lower housing shell defining a lower cavity and an upper housing shell defining an upper cavity. The upper housing shell is removably attachable to the lower housing shell and the upper and lower cavities define an interior compartment when the upper housing shell is attached to the lower housing shell. The upper housing shell has one or more perforations extending therethrough to fluidically couple the interior compartment and an exterior environment. One or more buoyancy members are configured to be removably received within the lower housing shell, the one or more buoyancy members having a receptacle formed therein for holding a supply of chum material.

In a more limited aspect, the one or more buoyancy members includes one or both of (1) a first buoyancy member having a specific gravity configured to produce a buoyant force when the chum dispenser system is placed in water; and (2) a second buoyancy member having a specific gravity configured to produce a sinking force when the chum dispenser system is placed in water.

In a further aspect, a chum dispenser system comprises a lower housing shell defining a lower cavity and an upper housing shell defining an upper cavity. The upper housing shell is removably attachable to the lower housing shell and the upper and lower cavities define an interior compartment when the upper housing shell is attached to the lower housing shell. The upper housing shell has one or more perforations extending therethrough to fluidically couple the interior compartment and an exterior environment. A buoyancy member is removably received within the lower housing shell, the buoyancy member having a receptacle formed therein for holding a supply of chum material.

In a more limited aspect, the buoyancy member has a specific gravity configured to produce a buoyant force when the chum dispenser system is placed in water.

In another more limited aspect, the buoyancy member has a specific gravity configured to produce a sinking force when the chum dispenser system is placed in water.

In certain embodiments, a plurality of buoyancy members having different specific gravities are provided, wherein the buoyancy members are interchangeably received within the lower housing shell.

In certain embodiments, first and second buoyancy members are provided, the first buoyancy member having a specific gravity configured to produce a buoyant force when the chum dispenser system is placed in water and the second buoyancy member having a specific gravity configured to produce a sinking force when the chum dispenser system is placed in water.

One advantage of the present disclosure is that it offers directional casting so that the user can cast the dispenser to a location where the fish are gathered and then cast an additional line with a fishing hook to where the fish are feeding on the chum.

Another advantage of the present development is that is allows the user to selectively configure the device to attract top, bottom, or subsurface feeding fish.

Yet another advantage of the present dispenser resides in its ability to be used on charter boats to increase customer satisfaction as the dispenser can be cast to any specific area.

Still further advantages and benefits of the present development will become apparent to those of ordinary skill in the art upon reading and understanding the following detailed description of the preferred embodiments.

### BRIEF DESCRIPTION OF THE DRAWING

The invention may take form in various components and arrangements of components, and in various steps and arrangements of steps. The drawings are only for purposes of illustrating preferred embodiments and are not to be construed as limiting the invention.

FIG. 1 is an elevation view of a retrievable chum dispenser in accordance with an exemplary embodiment of the invention.

FIG. 2 is a top plan view of the chum dispenser embodiment appearing in

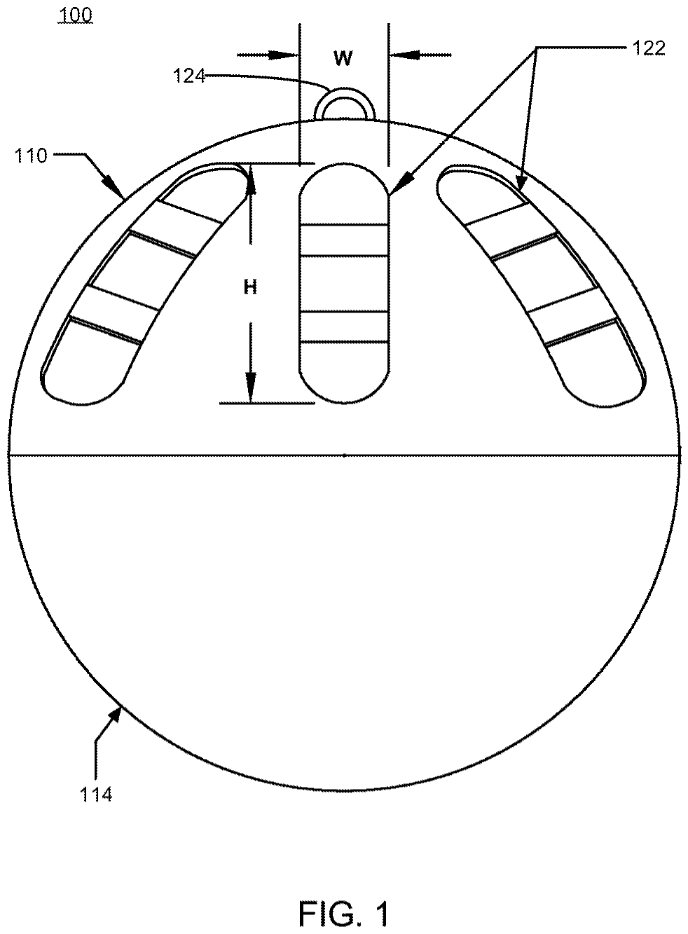

FIG. 1.

FIG. 3 is an exploded elevation view illustrating interchangeable buoyancy member for selectively configuring the device for surface fishing or bottom fishing.

FIG. 4 illustrates the retrievable chum dispenser in accordance with the present disclosure, configured for surface use.

FIG. 5 illustrates the retrievable chum dispenser in accordance with the present disclosure, configured for bottom use.

FIG. 6 illustrates the retrievable chum dispenser in accordance with the present disclosure, configured for subsurface use at a subsurface depth that is intermediate the surface of the water and the bottom.

FIG. 7 is an elevation view of a retrievable chum dispenser in accordance with a second exemplary embodiment of the invention.

### DETAILED DESCRIPTION OF THE PREFERRED EMBODIMENTS

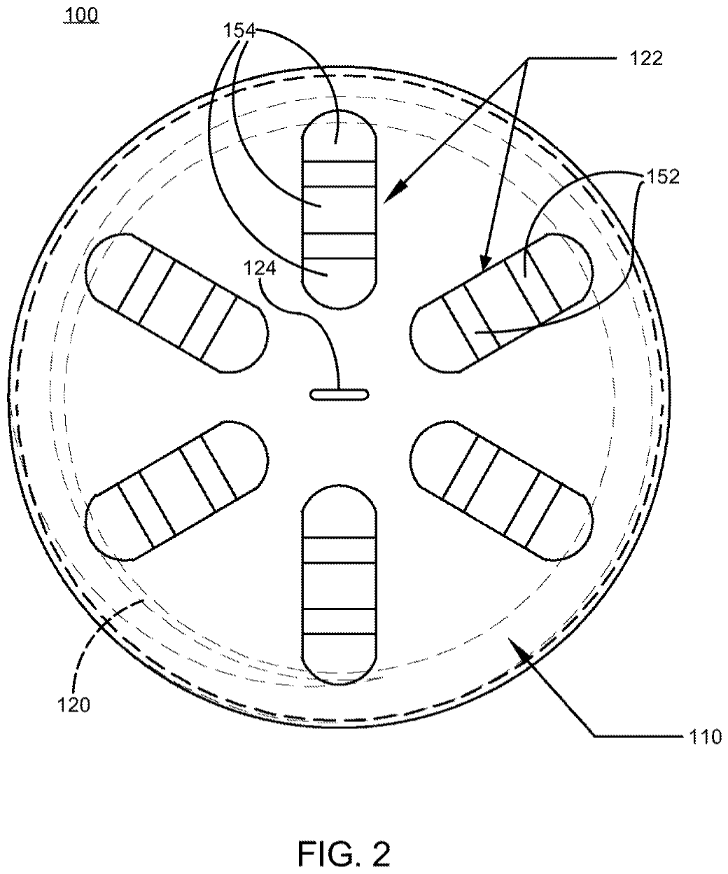

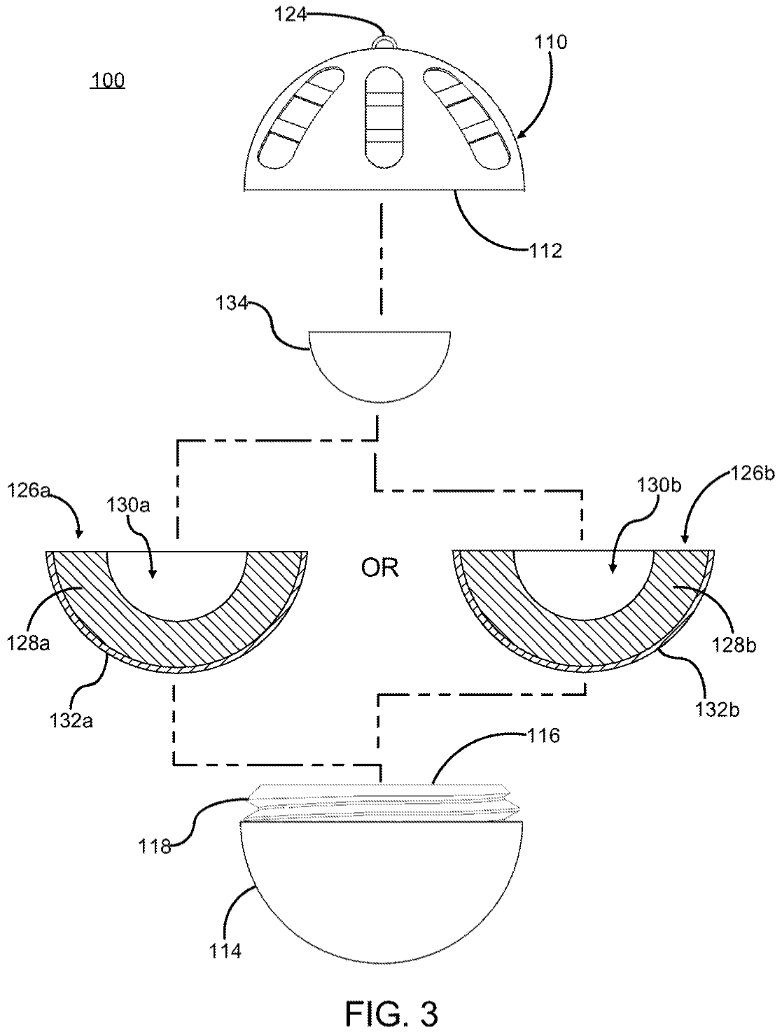

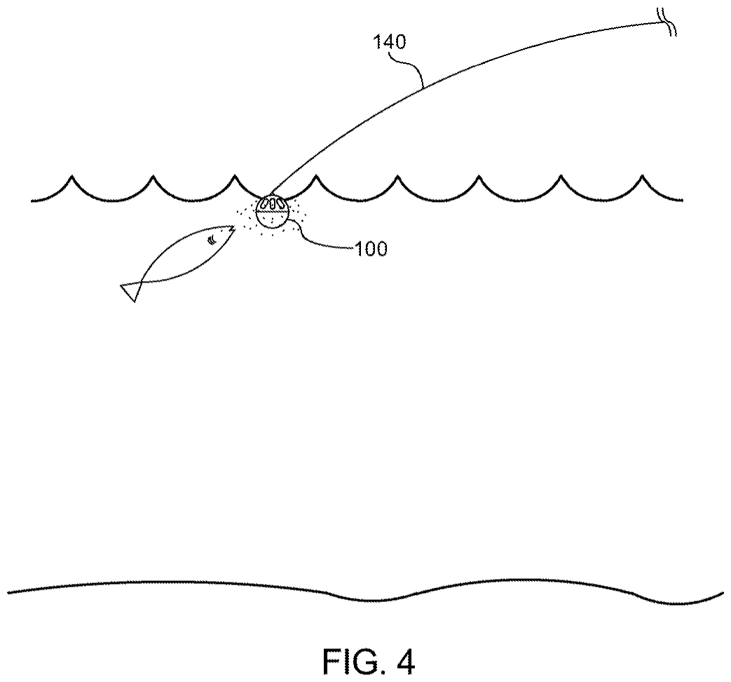

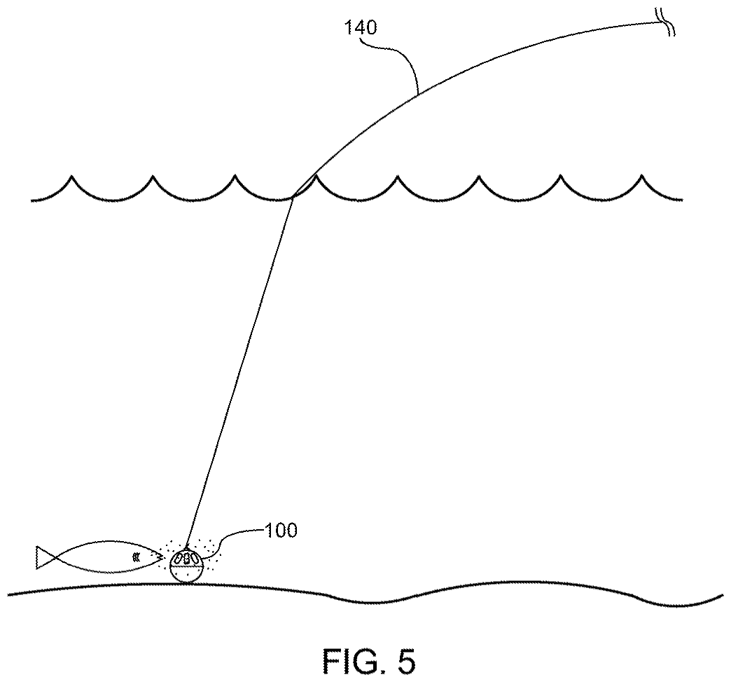

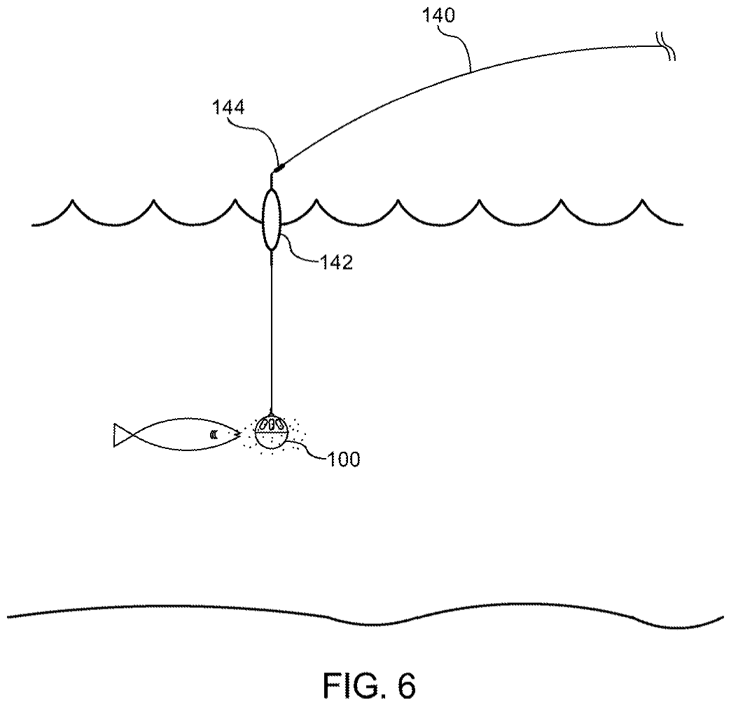

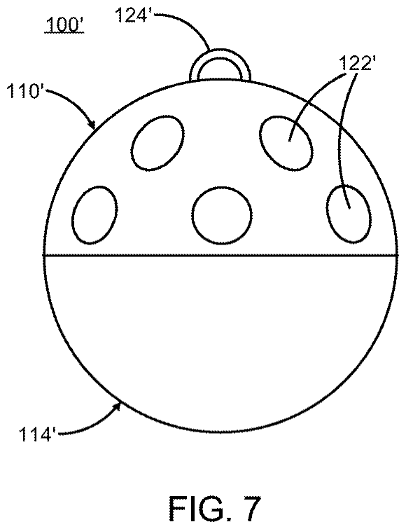

Referring now to the drawing FIGS. 1-6, a chum dispenser in accordance with the present development is designated generally as 100 and includes an upper shell 110 having an open end 112 and a lower shell 114 having an open end 116. Unless specifically stated otherwise, the terms “upper,” “lower,” and like terms refer to the orientation of the dispenser 100 as it appears in FIG. 1. The term “chum” is intended to encompass all manner of dispersible fish attractant materials, including without limitation fish, krill, worms, squid, amphibians, fish food, fish bait, fish scents, oils, and the like.

The upper shell 110 and the lower shell 114 are joined via their respective open ends 112, 116 to define a hollow interior compartment. The upper shell 110 and the lower shell 114 are removably joined via complementary fasteners. In certain embodiments, the lower shell 114 includes one or more external helical threads 118 at its open end 116 which engage one or more complementary internal helical threads 120 formed in the open end 112 of the upper shell 110. In alternative embodiments (not shown), the upper shell 110 may have one or more external helical threads which removably engage one or more complementary internal helical threads in the lower shell 114.

In the illustrated embodiment, the upper and lower shells 110, 114 are hemispherical and cooperate to define a generally spherical dispenser. It will be recognized that any other shape having a circular cross-section allowing a threaded connection between the shell halves can be used, including without limitation prolate spheroid, oblate spheroid, cylindrical, and so forth.

In certain embodiments, the upper shell 110 and the lower shell 114 are formed of a plastic material, including without limitation polyolefins (e.g., polyethylene or polypropylene), polyesters (e.g., polyethylene terephthalate), polyamides (e.g., nylon), polyimides, polyvinyl chloride, polycarbonate, acrylic polymers, and the like. In certain embodiments, the upper shell 110 and the lower shell 114 are formed via a molding process, e.g., injection molding. It will be recognized that the upper shell 110 and the lower shell 114 may be formed of other materials including other polymer materials, metal or metal alloy, and so forth. It will be recognized that the upper shell 110 and the lower shell 114 may be formed via molding, machining, die stamping, additive manufacturing, or combinations thereof.

The upper shell 110 includes a plurality of perforations 122 which provides a fluidic coupling between the interior compartment and the external environment, thereby allowing chum placed within the interior compartment of the unit 100 to dissipate into surrounding water. The number and size of the perforations is selected to provide a desired rate of release of the chum material into the surrounding water. In certain embodiments, the upper and/or lower shells 110, 114 may be formed of a colored material or have a colored surface. In certain embodiments, the color may be selected to allow the unit 100 to stand out from the surrounding environment to allow the user to visualize the location of the unit 100 in the water. In certain embodiments, the color may be selected to attract fish or a particular type of fish. In certain embodiments, the exterior surface of the upper and/or lower shells 110, 114 have a shiny or metallic finish as a fish attractant and/or as an aid to the user in visualizing the unit 100 when it is in the water.

In certain embodiments, the upper shell 110 includes a loop 124 for attaching the unit 100 to the end of a fishing line 140. The loop 124 may be integrally formed with the upper shell 110 or may be fastener, such as an eyelet, that is separately formed and attached to the shell 110. Positioning the loop 124 at other locations of the unit 100 is also contemplated. Alternatively, the loop 124 is omitted and the unit 100 is secured to the end of a fishing line 125 via openings in the upper shell 110. Such openings can be the perforations 122 or, alternatively, a separate set of openings (not shown) in the wall of the upper shell 110, e.g., specifically provided for attaching the fishing line 125. One or more buoyancy members 126a, 126b (two in the illustrated embodiment appearing in FIG. 3) are complementary in size and shape with the interior compartment of the lower shell 114 and a selected one is removably received therein. The buoyancy modules 126a, 126b define a cavity, compartment or receptacle 130a, 130b for receiving chum material 134. The buoyancy members 126a, 126b are shown in cross-section in FIG. 3 for ease of exposition. In this manner, the lower housing shell 114, the buoyancy member (e.g., 126a, 126b) and the chum material 134 form a nested configuration.

The chum compartment 126a includes a flotation body 128a having a recess or cavity 130a formed therein configured to receive a chum material 134. The flotation body 128a is formed of a relatively low specific gravity material to impart flotation to the unit 100. In certain embodiments, the flotation body 128a is formed of a buoyant material such as cork or a foam material (preferably, a closed cell foam material), including without limitation closed cell polystyrene, polyethylene, polypropylene, or the like. Optionally, the flotation body 128a includes a shell layer 132a, e.g., which may be formed of plastic, on the exterior surface thereof. In alternative embodiments, the flotation body 128a may be formed of a watertight enclosure of like shape which is substantially hollow. FIG. 4 illustrates the manner of using the unit 100 in a surface feeding configuration.

The chum compartment 126b includes a sinker body 128b having a recess or cavity 130b formed therein configured to receive the chum material 134. The sinker body 128b is formed of a relatively high specific gravity material to cause the unit 100 to sink during use. In certain embodiments, the sinker body 128b is formed of a metal, including but not limited to tungsten, lead, steel, stainless steel, brass, bronze, bismuth, tin, and alloys containing any of the foregoing, or other metal or metal alloy. Other high specific gravity materials include cementitious materials and composite materials comprising high specific gravity filler or aggregate materials in a polymer matrix. Optionally, the sinker body 128b includes a shell layer 132b, e.g., which may be formed of plastic, on the exterior surface thereof. FIG. 5 illustrates the manner of using the unit 100 in a surface feeding configuration.

In certain embodiments, when the sinker body 128b is selected, the unit can also be configured for subsurface chum dispensing at an intermediate position between the water surface and the bottom. The fishing rig used for casting the unit 100 can be configured to allow the unit 100 to sink to a desired depth below the surface by attaching a float or bobber 142 at a desired position on the line 140, or, using a slidable float or bobber 142 with a line stop 144 placed at a desired position on the line 140. In this manner, the sinker body 128b will cause the unit 100 to sink to an intermediate depth determined by the position of the bobber 142 or line stop 144.

Preferably, the chum material 134 is in the form of an insert such as a pod, capsule, tablet, or the like. Although the cavity 130a, 130b and the chum material 134 are illustrated as being generally hemispherical, it will be recognized that other complementary shapes are contemplated. In certain embodiments, the chum material 134 may take the form of a generally spherical insert such that it extends above the edge of the cavity 130a, 130b. In certain embodiments, the chum material 134, preferably freeze dried fish bait, is encapsulated within a water soluble capsule, such as a gelatin capsule. In certain embodiments, the chum materials is packaged within a water soluble packaging film, such as a water soluble polyvinyl alcohol (PVOH) film.

In certain embodiments, the chum material 134 may be in the form of a tablet comprising a fish attractant composition, preferably freeze dried fish bait, which is compressed, e.g., using a press and a complementary shaped die, to form an intact, compact mass that is shaped to fit onto the cavity 130a, 130b. In certain embodiments, binders are used to improve the cohesiveness of the chum insert 134. In certain embodiments, a water soluble coating or film may be provided on the chum insert 134 to control the rate of release of the chum material into the surrounding water.

In operation, the user places a selected one of the flotation body 128a and the sinker body 128b into the interior compartment of the lower shell 114, depending on whether the user wishes to surface fish or bottom fish, respectively, and the chum material 134 is placed into the respective cavity (130a or 130b). As noted above, feeding at a depth intermediate the surface and the bottom is accomplished using the sinker body 128b in combination with a float or bobber as described above. The upper and lower shells 110, 114 are then rotatably secured together via the threaded connection. In certain embodiments, the assembled unit 100 is then attached to a first fishing rig and cast to a desired location. The user may then fish with a second fishing rig, e.g., one having a baited hook, lure, or the like, in the vicinity of the unit 100. When it is desired to replenish the bait/chum 134 in the unit 100 or to fish in another location, the unit 100 can be reeled in and the upper shell 110 can be rotated in relation to the lower shell 114 to separate the two halves. The user may then replenish the chum material 134 and, if desired, switch from using the flotation body 128a to using the sinker body 128b, or vice versa.

In certain embodiments, a dispenser unit 100 that is configured for freshwater use has a diameter in the range of from about 1.5 inches to about 6 inches, preferably about 2.25 inches to about 4.5 inches, and most preferably about 2.75 inches. In certain embodiments, a dispenser unit 100 that is configured for freshwater use has a perforation height H in the range of from about 0.5 inches to about 2.5 inches, preferably about 0.75 inches to about 2 inches, and most preferably about 1 inch. In certain embodiments, a dispenser unit 100 that is configured for freshwater use has a perforation width W in the range of from about ⅛ inch to about 1 inch, preferably about ¼ inches to about 0.75 inch, and most preferably about ⅜ inch. In the illustrated embodiment, one or more strips 152 extend across the perforations 112 to divide the perforations into a plurality of smaller perforations 154 to slow the rate at which the chum material exits the interior compartment during use. It will be recognized that other dimensions and perforation shapes or patterns are contemplated.

In certain embodiments, a dispenser unit 100 that is configured for saltwater use has a diameter in the range of from about 1.75 inches to about 7 inches, preferably about 2.75 inches to about 5.5 inches, and most preferably about 3.5 inches. In certain embodiments, a dispenser unit 100 that is configured for saltwater use has a perforation height H in the range of from about 0.75 inches to about 3 inches, preferably about 1 inch to about 2.5 inches, and most preferably about 1.25 inches. In certain embodiments, a dispenser unit 100 that is configured for saltwater use has a perforation width W in the range of from about 0.25 inches to about 1.25 inches, preferably about 5/16 inches to about 1 inch, and most preferably about 0.5 inch. It will be recognized that other dimensions and perforation shapes or patterns are contemplated.

Referring now to FIG. 7, there is shown an alternative embodiment dispenser unit 100′ having an upper shell 110′ and a lower shell 114′. The upper shell includes a plurality of perforations 122′. In certain embodiments, an attachment loop 124′ is provided on the upper shell 110′ for securing the unit 100′ to a fishing line. Alternative means of securing the device 100 to the fishing line may also be provided as discussed above in place of the loop 124′. The device 100′ differs from the device 100 discussed above by way of reference to FIGS. 1-3 with respect to the shape of the perforations 122′, but may otherwise be as described above with respect to the device 100. In the illustrated embodiment of FIG. 7, the perforations 122′ are illustrated as being generally circular in shape, although it will be recognized that the perforations may be any other shape, including oval, rectangular, triangular, fish-shaped, or any other shape, or any combination of shapes.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiments, the invention is now claimed to be:

1. A chum dispenser system, comprising:
a lower housing shell defining a lower cavity;
an upper housing shell defining an upper cavity, the upper housing shell removably attachable to the lower housing shell, the upper and lower cavities defining an interior compartment when the upper housing shell is attached to the lower housing shell, the upper housing shell having one or more perforations extending therethrough to fluidically couple the interior compartment and an exterior environment; and
two or more interchangeable buoyancy members configured to be removably and interchangeably received within the lower housing shell, each of the two or more buoyancy members having a receptacle formed therein for holding a supply of chum material.

2. The chum dispenser system of claim 1, wherein each of the two or more buoyancy members has a different specific gravity.

3. The chum dispenser system of claim 1, wherein the two or more buoyancy members include a first buoyancy member having a specific gravity configured to produce a buoyant force when the chum dispenser system is placed in water and a second buoyancy member having a specific gravity configured to produce a sinking force when the chum dispenser system is placed in water.

4. The chum dispenser system of claim 3, wherein the first buoyancy member comprises one or more of a cork material, a foam material, and a substantially hollow watertight enclosure.

5. The chum dispenser system of claim 3, wherein the first buoyancy member comprises a closed cell foam material.

6. The chum dispenser system of claim 3, wherein the second buoyancy member comprises a material selected from the group consisting of a metal, metal alloy, cementitious material, composite material, tungsten, lead, steel, stainless steel, brass, bronze, bismuth, tin, and any combination of the foregoing.

7. The chum dispenser system of claim 1, wherein the chum material is a dispersible fish attractant material selected from the group consisting of fish, krill, worms, squid, amphibians, fish food, fish bait, fish scents, oils, and any combination of the foregoing.

8. The chum dispenser system of claim 1, wherein the chum material comprises a fish attractant encapsulated within a water soluble material.

9. The chum dispenser system of claim 8, wherein the water soluble material is selected from the group consisting of a gelatin capsule and a water soluble polymer film.

10. The chum dispenser system of claim 1, wherein the fish attractant comprises freeze dried fish bait.

11. The chum dispenser system of claim 1, wherein the chum material is a tablet.

12. The chum dispenser system of claim 11, wherein the tablet comprises a water soluble coating.

13. The chum dispenser system of claim 1, wherein the lower housing shell includes a first threaded fastening element and the upper housing shell includes a second threaded fastening element which is complementary with the first threaded fastening element, the first and second threaded fastening elements for rotatable attaching the lower housing shell to the upper housing shell.

14. The chum dispenser system of claim 13, wherein the first threaded fastening element includes an external helical thread adjacent an open end of the lower housing shell and wherein the second threaded fastening element includes an internal helical thread adjacent an open end of the upper housing shell.

15. The chum dispenser system of claim 13, wherein the first threaded fastening element includes an internal helical thread adjacent an open end of the lower housing shell and wherein the second threaded fastening element includes an external helical thread adjacent an open end of the upper housing shell.

16. The chum dispenser system of claim 1, wherein each of the lower housing shell and the upper housing shell are hemispherical in shape.

17. The chum dispenser system of claim 1, wherein at least one of the upper housing shell and the lower housing shell further comprises a loop for attaching the chum dispenser system to a fishing line.

18. A chum dispenser system, comprising:
a lower housing shell defining a lower cavity;
an upper housing shell defining an upper cavity, the upper housing shell removably attachable to the lower housing shell, the upper and lower cavities defining an interior compartment when the upper housing shell is attached to the lower housing shell, the upper housing shell having one or more perforations extending therethrough to fluidically couple the interior compartment and an exterior environment; and
one or more buoyancy members configured to be removably received within the lower housing shell, the one or more buoyancy members having a receptacle formed therein for holding a supply of chum material.

19. A chum dispenser system of claim 18 wherein the one or more buoyancy members includes one or both of:
a first buoyancy member having a specific gravity configured to produce a buoyant force when the chum dispenser system is placed in water; and
a second buoyancy member having a specific gravity configured to produce a sinking force when the chum dispenser system is placed in water.
